(19) United States
(12) Patent Application Publication
(10) Pub. No.: US 2009/0216494 A1
(43) Pub. Date: Aug. 27, 2009

(54) Network Laser System with Remote Diagnostics

(76) Inventors: Andrew D. Stadler, San Francisco, CA (US); David Goldman, Napa, CA (US); Mark Farley, Napa, CA (US); Michael M. Mielke, Santa Rosa, CA (US)

Correspondence Address: CARR & FERRELL LLP, 2200 GENG ROAD, PALO ALTO, CA, 94303, US

(21) Appl. No.: 12/363,636

(22) Filed: Jan. 30, 2009

Related U.S. Application Data
(63) Continuation-in-part of application No. 11/740,874, filed on Apr. 26, 2007.
Application No. 11/740,874 is a continuation-in-part of application No. 12/259,176, filed on Oct. 27, 2008.
Application No. 12/259,176 is a division of application No. 11/615,883, filed on Dec. 22, 2006, now Pat. No. 7,444,049.
(60) Provisional application No. 60/796,646, filed on Apr. 26, 2006.
(60) Provisional application No. 60/761,736, filed on Jan. 23, 2006.
(60) Provisional application No. 60/762,284, filed on Jan. 25, 2006.
(60) Provisional application No. 60/763,002, filed on Jan. 26, 2006.
(60) Provisional application No. 60/762,791, filed on Jan. 26, 2006.
(60) Provisional application No. 60/762,790, filed on Jan. 26, 2006.

(51) Int. Cl. G21C 17/00; H01S 3/00

(52) U.S. Cl. 702/183; 372/38.1

(57) ABSTRACT

In exemplary embodiments, a network laser system comprises a laser platform including an optical source configured to generate an optical pulse, an optical amplifier configured to amplify the optical pulse, and a compressor configured to temporally compress the amplified optical pulse. The network laser system may also comprise monitor circuitry (e.g., sensors) configured to monitor one or more performance aspects of the laser platform. The network laser system may further comprise logic configured to transmit data to a remote computing device over a network. The network laser system may be configured to perform a diagnostic test and/or maintenance in response to instructions received from the remote computing device.

### CROSS-REFERENCE TO RELATED APPLICATIONS

This application is a continuation-in-part and claims the priority benefit of U.S. patent application Ser. No. 11/740,874 entitled “Intelligent Laser Interlock System” and filed on Apr. 26, 2007, which claims the priority benefit of U.S. Provisional Patent Application Ser. No. 60/796,646 entitled “Laser System Software Development Platform” and filed on Apr. 26, 2006. This application is also a continuation-in-part and claims the priority benefit of U.S. patent application Ser. No. 12/259,176 entitled “Systems and Methods for Control of Ultra Short Pulse Amplification” and filed on Oct. 27, 2008, which is a divisional of U.S. patent application Ser. No. 11/615,883 entitled “Pulse Stretcher and Compressor Including a Multi-Pass Bragg Grating” and filed on Dec. 22, 2006, which claims the priority benefit of U.S. Provisional Patent Application Ser. No. 60/761,736 entitled “Method of Dispersion Compensation in a CPA System” and filed on Jan. 23, 2006, U.S. Provisional Patent Application Ser. No. 60/762,284 entitled “USP Laser Fiber Amplifier” and filed on Jan. 25, 2006, U.S. Provisional Patent Application Ser. No. 60/763,002 entitled “Seed Control In Ultra Short Pulse Laser Systems” and filed on Jan. 26, 2006, U.S. Provisional Patent Application Ser. No. 60/762,791 entitled “Amplifier Control In Ultra Short Pulse Laser Systems” and filed on Jan. 26, 2006, and U.S. Provisional Patent Application Ser. No. 60/762,790 entitled “Method Of Remote Access To An Ultra Short Pulse Laser System” and filed on Jan. 26, 2006. This application is also related to co-pending U.S. patent application Ser. No. ______ entitled “Automated Laser Tuning” and filed on even date herewith. Each of the above patent applications and patents are hereby incorporated by reference.

### BACKGROUND

1. Field of the Invention

The present invention relates in general to the field of light amplification and computer networking, and more particularly to the field of network laser systems with remote diagnostics.

2. Description of Related Art

Chirped Pulse Amplification (CPA) is very useful for producing ultra short-duration high-intensity pulses for use in high peak power ultra short pulse laser systems. CPA increases energy of an ultra short laser pulse while avoiding optical amplifier damage and excessive nonlinear distortion. In this technique, a duration of the pulse is first increased by dispersing the ultra short laser pulse temporally as a function of wavelength (a process called “chirping”) to produce a chirped pulse. The chirped pulse is then amplified and recompressed to significantly shorten its duration. Lengthening the pulse in time reduces the peak power of the pulse and, thus, allows energy to be added to the pulse without incurring excessive nonlinearities or reaching a damage threshold of the pulse amplifier and optical components. An amount of pulse amplification that can be achieved is typically proportional to the amount of pulse stretching and compression. Typically, the greater the amount of stretching and compression, the greater the possible pulse amplification.

A CPA system typically comprises an optical stretcher, an optical amplifier, and an optical compressor. The optical stretcher and optical compressor are ideally configured to have equal but opposite dispersive properties to perfectly compensate for one another to minimize the pulse width of an amplified optical pulse. The optical stretcher may comprise a bulk diffraction grating, an optical fiber, a fiber grating, or other dispersive optical elements. Optical fiber-based dispersive optical elements are generally not used in the optical compressor because the peak power of an optical pulse within the optical compressor is generally larger than an optical fiber's nonlinear threshold. Therefore, bulk diffraction gratings are generally used in optical compressors due to the ability of bulk diffraction gratings to handle larger optical power levels than optical fibers.

Any material through which an optical pulse propagates, such as a waveguide in an optical amplifier, may add dispersion to the optical pulse. This additional dispersion may not be compensated by a perfectly matched optical stretcher and compressor pair. In addition, dispersion properties of the components of an ultra short pulse amplification system may be sensitive to temperature as well as minute variations in the parameters and physical configuration of the system components. Therefore, adjustment of various parameters and positions of the system components may be required on a regular and periodic basis to maintain desired system operation. Traditionally, this has made hands-on operation and adjustment by knowledgeable and experienced laser system experts required to properly use ultra short pulse amplification systems.

### SUMMARY

In exemplary embodiments, a network laser system comprises a laser platform including an optical source configured to generate an optical pulse, an optical amplifier configured to amplify the optical pulse, and a compressor configured to temporally compress the amplified optical pulse. The network laser system may also comprise monitor circuitry (e.g., sensors) configured to monitor one or more performance aspects of the laser platform. The network laser system may further comprise logic configured to transmit data to a remote computing device over a network. The network laser system may be configured to perform a diagnostic test and/or maintenance in response to instructions received from the remote computing device.

### BRIEF DESCRIPTION OF THE DRAWINGS

FIG. 1 illustrates an exemplary network laser system environment.

FIG. 2 illustrates an exemplary hierarchical network laser control system.

FIG. 3 illustrates exemplary modules of the application control software system.

FIG. 4 illustrates an exemplary laser application control system development environment.

FIG. 5 illustrates an exemplary method of interfacing a laser platform with a computing device.

FIG. 6 illustrates an exemplary method of controlling a laser platform over a network.

FIG. 7 illustrates an exemplary controller.

### DETAILED DESCRIPTION

In various embodiments of the present invention, logic may be integrated with an ultra short pulse system to provide networked control and remote diagnostics of the ultra short pulse system. The logic may include digital devices such as processors, integrated circuits, firmware, memory, and software programs configured to control and/or monitor the ultra short pulse system in communication with one or more remote computing devices. In this way, a remote computing device may remotely monitor and control one or more ultra short pulse systems in coordination with one another. The remote computing device may also remotely diagnose, maintain, and update the ultra short pulse system. Thus, the ultra short pulse system may operate and be maintained independently according to pre-programmed parameters in coordination with one or more other ultra short pulse systems without manual intervention. The ultra short pulse system may operate and be maintained more efficiently than if manual control and/or maintenance were required. Network control, diagnostics, and maintenance of the ultra short pulse system may facilitate applications which would not be practical otherwise.

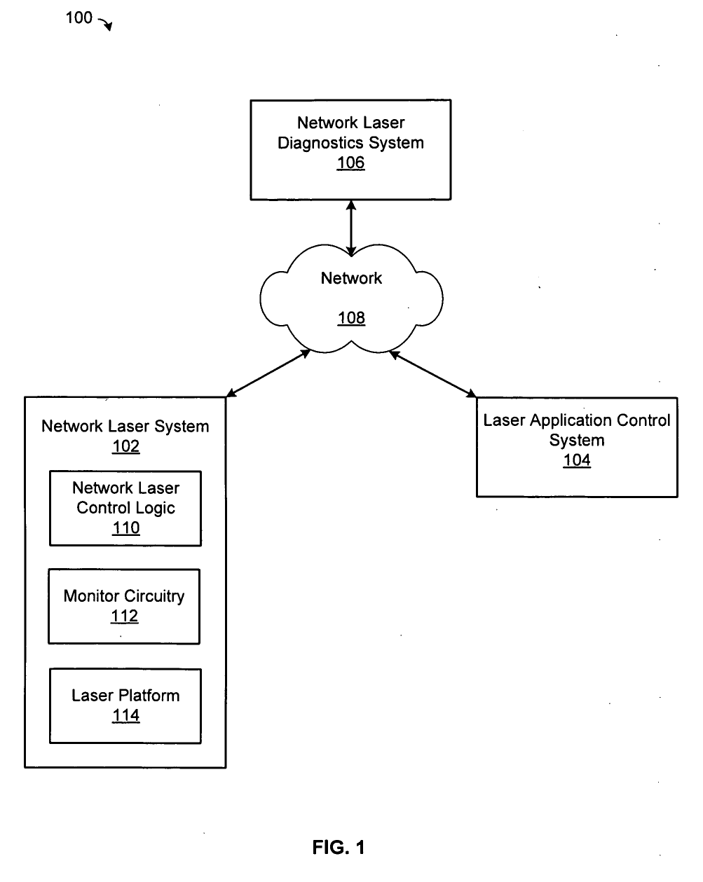

FIG. 1 illustrates an exemplary network laser system environment 100. The network laser system environment 100 comprises a network laser system 102, a laser application control system 104, and a network laser diagnostics system 106, all of which are coupled by a network 108. Any of these systems may comprise a computing device. The network laser system 102 comprises a network laser control logic 110 configured to control one or more performance aspects of the network laser system 102. The network laser control logic 110 may also be configured to provide an interface to the network 108 such that the network laser system 102 may behave as a network device conforming to relevant network communication standards. The network laser control logic 110 may use control system processes involving feedback and control loops to control-system control a laser platform 114. For example, a proportional, integral, derivative (PID) control algorithm may be used. Examples of the laser platform 114 include a chirped pulse amplification system and an ultra short pulse laser system.

The network laser system 102 may also include monitor circuitry 112. The monitor circuitry 112 may be configured to monitor performance aspects of the laser platform 114 and provide performance data to the network laser control logic 110. The monitor circuitry 112 may include sensors such as temperature sensors, current sensors, voltage sensors, optical power sensors, optical energy sensors, pulse repetition rate sensors, pulse duration sensors, position sensors, accelerometers, etc. In some embodiments, the monitor circuitry 112 may include a video camera. The video camera may be configured to capture images in a visible spectrum, ultra violet spectrum, and/or infrared spectrum. The monitor circuitry 112 may be coupled with various constituent components of the laser platform 114. The monitor circuitry 112 may also monitor performance aspects of the network laser control logic 110.

The network laser control logic 110 may also be configured to communicate data over the network 108. For example, the network laser control logic 110 may be configured to transmit performance measurement data to the laser application control system 104 and/or the network laser diagnostics system 106. As another example, the network laser control logic 110 may be configured to receive data such as commands or software updates from the laser application control system 104 and/or the network laser diagnostics system 106.

The laser application control system 104 may include a processor configured to execute instructions stored on a memory to perform a method for using the network laser system 102 in an application. The laser application control system 104 may comprise a remote command station for user command and control of the network laser system 102. In some embodiments, the laser application control system 104 may communicatively couple with the network laser system 102 via a wired connection using a communications protocol such as RS-232, USB (Universal Serial Bus), GPIO (General Purpose Input/Output), GPIB (General Purpose Interface Bus)/IEEE-488, or I2C (Inter-Integrated Circuit). In other embodiments, the laser application control system 104 may communicatively couple with the network laser system 102 via the network 108 using a networking protocol such as TCP (Transmission Control Protocol), IP (Internet Protocol), and/or Ethernet over a wired (e.g., 10BASE-T or 100Base-T) or wireless (e.g., Wi-Fi, WiMax, or Bluetooth) connection. Alternatively, the laser application control system 104 may communicatively couple with the network laser system 102 via a telephonic connection. The laser application control system 104 may also include user interface and I/O components such as a video display screen, keyboard, mouse, joystick, touchpad, touch screen, tablet, printer, disk drive, CD-ROM drive, DVD-ROM drive, etc. The laser application control system 104 may be configured to interface with a user and/or various digital devices to perform high-level control functions for the network laser system 102.

In some embodiments, the laser application control system 104 may comprise a general purpose computing system based on a commercially available operating system such as LINUX or WINDOWS. In other embodiments, the laser application control system 104 may comprise a dedicated computing system, such as a single board computer, optionally based on a real-time operating system. In these other embodiments, the dedicated computing system may include hardware-oriented user interface components such as knobs, push-buttons, switches, display lamps, etc. In other embodiments, the laser application control system 104 may comprise a machine control platform (e.g., Numerical Control or G-Code). In still other embodiments, the laser application control system 104 may comprise a portable computing device such as a personal digital assistant (PDA).

The laser application control system 104 may be configured to monitor and control the network laser system 102 over the network 108 such that a user of the network laser system 102 may be physically remote from the network laser system 102. For example, the laser application control system 104 may control laser system variables such as pulse repetition rate, pulse intensity, pulse energy, pulse duration, programmed pulse packet patterns, material-specific ablation rate, and/or system component temperature. The laser application control system 104 may also receive information (e.g., data from the monitor circuitry 112) from the network laser system 102 in real time. The information may be used as feedback in one or more control loops configured to control performance parameters or variables of the laser platform 114. The laser application control system 104 may optionally store (i.e., log) data from the network laser system 102 including data from specific subsystems and/or components included in the network laser system 102.

The laser application control system 104 and/or the network laser diagnostics system 106 may be configured to update programming (e.g., software, firmware, or field programmable gate array (FPGA) logic) of the network laser system 102 and/or the network laser control logic 110 remotely over the network 108. For example, such programming updates may be used to improve system performance, provide for system diagnostics, and/or add new application functionality.

The laser application control system 104 may also provide a data resource to the network laser system 102. In one instance, the network laser system 102 may automatically request and obtain information from the laser application control system 104. For example, the information may include component, subsystem, or system parameter settings appropriate for a particular material to be ablated by the laser platform 114. These settings may be stored in an electronic library (e.g., data warehouse) coupled with the laser application control system 104.

In exemplary embodiments, the laser application control system 104 may be configured to control more than one network laser system 102. For example, the laser application control system 104 may control a plurality of network laser systems 102 in a coordinated manner for an application that requires more than one network laser system 102. Alternatively, multiple laser application control systems 104 may be configured to communicate and coordinate with one another over the network 108, each of which may control one or more network laser systems 102.

In exemplary embodiments, the network laser diagnostics system 106 may communicate with one or more distributed network laser systems 102 and provide a centralized diagnostics, reporting, or performance monitoring functionality. The network laser diagnostics system 106 may be physically separated from the network laser system 102 (e.g., in a different part of a room, a different room, a different building, or a different municipality). Thus, the network laser diagnostics system 106 may be physically separated from the network laser system 102 by a meter, a kilometer, one hundred kilometers, or more. The network laser diagnostics system 106 may therefore provide remote diagnostics and maintenance of the network laser system 102. In one example, a service technician may use the network laser diagnostics system 106 to monitor, diagnose, adjust, and tune the network laser system 102 remotely over the network 108 without physically seeing or touching the network laser system 102. The service technician may also determine what repairs or parts replacements are needed for the network laser system 102 prior to traveling to a location of the network laser system 102 to make the necessary parts repairs or replacements.

The exemplary network laser diagnostics system 106 may be configured to conduct performance evaluations of components and subsystems included in the network laser system 102. In some embodiments, the network laser system 102 may analyze measurement data and/or store operational and/or maintenance logs including the measurement data of the network laser system 102. The network laser system 102 may then transmit the stored logs to the network laser diagnostics system 106, or the stored logs may be physically transported to the network laser diagnostics system 106 via a computer readable storage medium, such as a CD-ROM, DVD-ROM, magnetic tape, flash memory, etc.

The network laser diagnostics system 106 may also remotely control diagnostics and tests of the network laser system 102. In exemplary embodiments, the network laser diagnostics system 106 may diagnose deviations in laser system performance from reference specifications. As a result of the performance evaluations, diagnostics, and/or tests, the network laser diagnostics system 106 may convey information to a user of the network laser system 102 relating to recommended or necessary maintenance, including a schedule and list of components which may need replacement. The network laser diagnostics system 106 may also perform corrective maintenance of the network laser system 102 remotely over the network 108.

In some embodiments, customer support and/or billing may be provided based upon results of analysis, performance evaluations, diagnostics, and/or tests performed by the network laser diagnostics system 106. In one example, the network laser system 102 may monitor customer usage of the network laser system 102 as a whole and/or individual features and capabilities. The customer usage information may be transmitted to the network laser diagnostics system 106, which may then perform analysis to predict maintenance requirements and/or generate customer bills relating to the customer's usage of the network laser system 102.

The network laser diagnostics system 106 may be further configured to monitor multiple network laser systems 102, each of which may be owned and/or operated by a different customer. The network laser diagnostics system 106 may therefore track both customer trends (e.g., customer usage versus elapsed time) and laser performance trends (e.g., laser performance versus time used). The network laser diagnostics system 106 may aggregate the tracked data across network laser system 102 model, customer application, customer industry, etc. Alternatively, the network laser diagnostics system 106 may directly associate the tracked data with specific network laser systems 102 (e.g., via serial numbers, MAC addresses, and/or IP addresses) and/or specific customers. The network laser diagnostics system 106 may also correlate data from multiple network laser systems 102 for analysis.

In some embodiments, analysis may be performed on laser performance aspects such as operating temperature or current levels in a seed laser or optical source. Because correlation between component usage and failure may be well established (e.g., the lifetime of a seed laser at a given driving current may be a known quantity), analysis of the laser performance aspect may be used to predict failure or requirements for component replacement or maintenance.

In other embodiments, analysis may be performed on a power level of a fiber amplifier to predict maintenance requirements for the fiber amplifier. For example, a photodarkening effect of the fiber may cause the fiber amplifier to require more power to maintain a given amplification factor over time as the photodarkening effect progresses. By analyzing the power required by the fiber amplifier, future maintenance requirements of the fiber amplifier and/or laser platform 114 may be predicted in advance. Therefore, the laser platform 114 may be proactively maintained and serviced rather than waiting for failure of the laser platform 114 to perform according to specifications.

In some embodiments, the functions of the network laser diagnostics system 106 may be performed by the laser application control system 104, and vice versa. Additionally, there may be more than one of any of the network laser system 102, laser application control system 104, and the network laser diagnostics system 106. The network laser diagnostics system 106 may communicate with more than one network laser system 102 and/or laser application control system 104. Likewise, the laser application control system 104 may communicate with more than one network laser system 102 and/or network laser diagnostics system 106. Furthermore, the network laser system 102 may communicate with more than one laser application control system 104 and/or network laser diagnostics system 106.

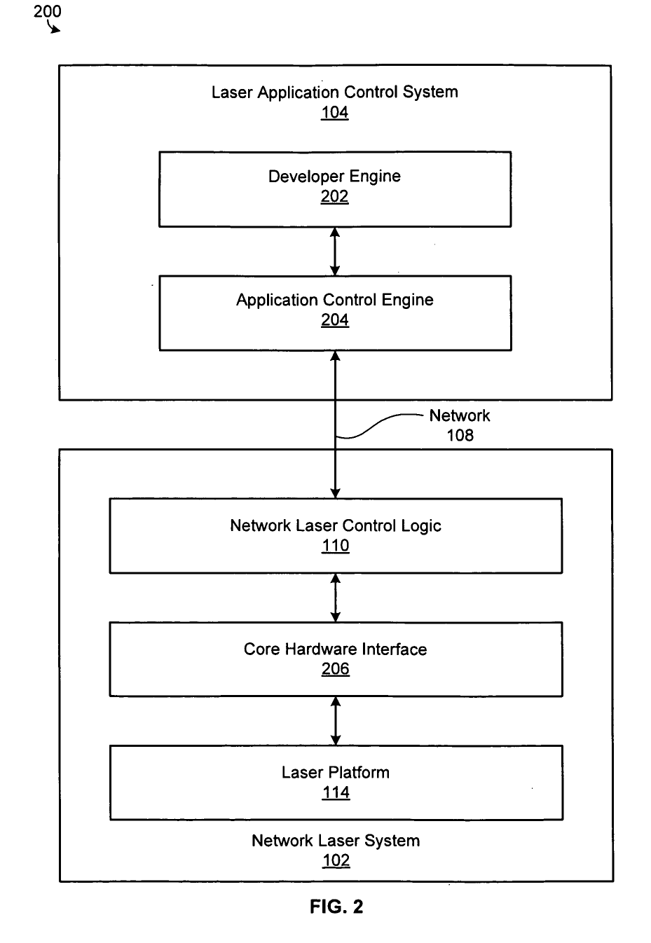

FIG. 2 illustrates an exemplary hierarchical network laser control system 200. The hierarchical network laser control system 200 may be configured to provide a user-programmable computer-controlled laser system that can be networked with any number of other laser systems and computer systems. The hierarchical network laser control system 200 may provide multiple hierarchical levels of control. Each level of control may represent logical demarcations between system elements that have significant differences in performance requirements or are best controlled using different approaches.

In exemplary embodiments, the hierarchical network laser control system 200 includes the laser application control system 104 and the network laser system 102. In some embodiments, the laser application control system 104 may be physically separated from the network laser system 102. The laser application control system 104 may therefore provide remote access and control of the network laser system 102. The laser application control system 104 may communicate with the network laser system 102 over the network 108. The laser application control system 104 may comprise a computer system having a processor and memory configured to store programs. The programs may include instructions for execution on the processor. The programs may include software configured to perform methods of using the network laser system 102 for various applications.

The laser application control system 104 may be configured to provide high-level control of the network laser system 102. In one embodiment, the laser application control system 104 includes a developer engine 202 and an application control engine 204. The application control engine 204 may include an application control interface and modules configured to provide high-level control functionality of the network laser system 102 to an external software application. The developer engine 202 may include a program or module developed specifically to interface with the application control engine 204 to adapt the network laser system 102 to a particular custom application. For example, the custom application may include laser ablation, machining, cutting, surgery, spectroscopy, multiple beam delivery systems, motion control, encoders, or scientific research.

The exemplary network laser system 102 comprises the network laser control logic 110, the laser platform 114, and a core hardware interface 206. The core hardware interface 206 may include circuitry to interface the network laser control logic 110 and the laser platform 114 together for monitoring and control. In some embodiments, the core hardware interface 206 may include the monitor circuitry 112 and actuators for control of the laser platform 114.

The core hardware interface 206, in conjunction with the network laser control logic 110 and the laser platform 114, may provide one or more feedback and low-level control loops. The low-level control loops may be nested and/or operate in parallel with one another. The low-level control loops may include hardware control loops and/or software control loops. Furthermore, the low-level control loops may use control system processes or modules to control-system control the laser platform 114.

The network laser control logic 110 may comprise a dedicated computing system (e.g., a single board computer having a processor and memory), which may include a real-time operating system (RTOS) and a program having instructions configured to perform a method for control and monitoring of the laser platform 114. The network laser control logic 110 may provide lower levels of control of the laser platform 114 relative to the laser application control system 104. The network laser control logic 110 may respond to high-level control commands received from the laser application control system 104 by performing lower-level control of the laser platform 114 needed to function in accordance with high-level control commands. For example, the high-level control commands may include “set laser system power on,” “read laser ready status,” “set laser beam power,” “set beam on,” “set beam off,” and so forth. The network laser control logic 110 may also be responsible for monitoring laser performance, logging of data, performing laser system diagnostics, and tuning laser parameters.

In some embodiments, the network laser system 102 may include input/output (I/O) components such as a front panel, a text or video display, keyboard or buttons, or a printer. In these embodiments, the network laser system 102 may function independently of the laser application control system 104 in response to direct input from a user. The input or output may include system power on/off, beam control functions, and/or display of laser and system status information.

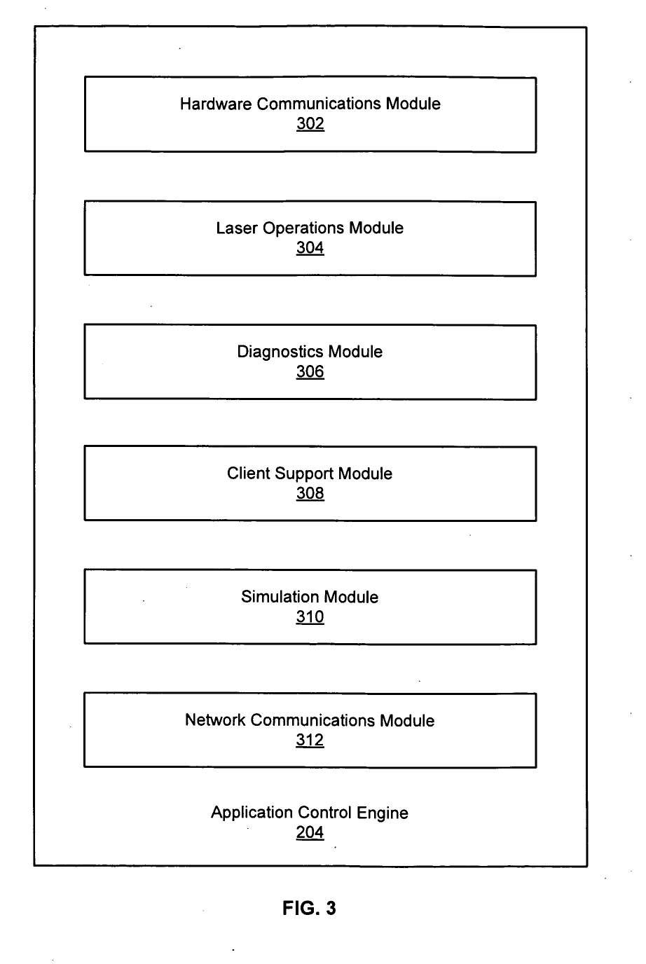

FIG. 3 illustrates exemplary modules of the application control engine 204. In various embodiments, the application control engine 204 comprises a hardware communications module 302, a laser operations module 304, a diagnostics module 306, a client support module 308, a simulation module 310, and a network communications module 312. The modules of the application control engine 204 may function in conjunction with one another to provide a programming environment for the development of applications that utilize the network laser system 102. Some modules of the application control engine 204 may be optional in some embodiments, and a developer of applications that interface with the application control engine 204 may not have access to all modules. Additional modules may also be included for additional functionality. In addition, one or more modules may be configured to include encryption and security. The modules may include library files and interface files which may be compiled by a compiler into executable files or a runtime environment.

The hardware communications module 302 may be configured to perform functions related to direct interaction with the network laser system 102 on behalf of the application control engine 204. The hardware communications module 302 may include an application programming interface (API) configured to enable external software packages to interface with the application control engine 204 for control, monitoring, and communication with the network laser system 102. The API may provide functions that map directly to commands of the network laser control logic 110.

The laser operations module 304 provides control functionality for the laser platform 114. In exemplary embodiments, the laser operations module 304 may enforce rules and limitations pertaining to the laser platform 114, and thereby prevent external software packages that interface to the application control engine 204 from causing the laser platform 114 to operate in an improper and/or unsafe manner. The laser operations module 304 may send commands to, and communicate with, the network laser system 102 via the hardware communications module 302.

The diagnostics module 306 provides functionality relating to performing diagnostics and logging of data related to operation of the laser platform 114. Example functions include collecting and preparing operations reports and error reports for external analysis. The diagnostics module 306 may also include high-level diagnostics that utilize statistics to predict laser operation conditions based on monitored data provided by the network laser system 102. These predictions may be used to determine when laser system maintenance may be required, including when some parts may need replacement. The diagnostics may utilize statistics and predictions provided by the network laser control logic 110. In some embodiments, the external analysis and/or diagnostics may be performed by the network laser diagnostics system 106.

The client support module 308 provides customer and lifecycle support operations such as functionality relating to software license management and software upgrades. The client support module 308 may also provide functionality relating to software and laser system security.

The simulation module 310 may be configured to perform a simulation of the network laser system 102. The developer engine 202 may interface with the simulation module 310 as a tool for predicting a response of the network laser system 102 to commands issued by the developer engine 202. In this way, software for the developer engine 202 may be developed and tested independently without utilizing the network laser system 102. As a result, software development for the developer engine 202 can be accelerated and costs can be lowered. The simulation module 310 may also include a dedicated programming interface to support programmed control of a simulation environment.

In an exemplary embodiment, the developer engine 202 may be configured to turn on a laser beam of the network laser system 102. The developer engine 202 may call a “beam control” API function call in the application control engine 204 to turn on the laser beam. The “beam control” API function may then utilize the laser operations module 304 to check parameters and rules pertaining to beam control of the network laser system 102. If the laser operations module 304 determines that activating the laser beam is safe and proper under current operating conditions of the network laser system 102, the hardware communications module 302 may then format and send a command message to the network laser control logic 110 to activate the laser beam. The network laser control logic 110 may then receive and decode the command message, check that activating the laser beam is safe and proper under the current operating conditions of the laser platform 114, and then activate the laser beam via the core hardware interface 206.

In other exemplary embodiments, the developer engine 202 may be configured to control a power level of a laser beam in the network laser system 102, use real-time GPIO (General Purpose Input Output) inputs to vary operational characteristics of the network laser system 102, and/or control operation of the network laser system 102 according to scripted input or from a remote source.

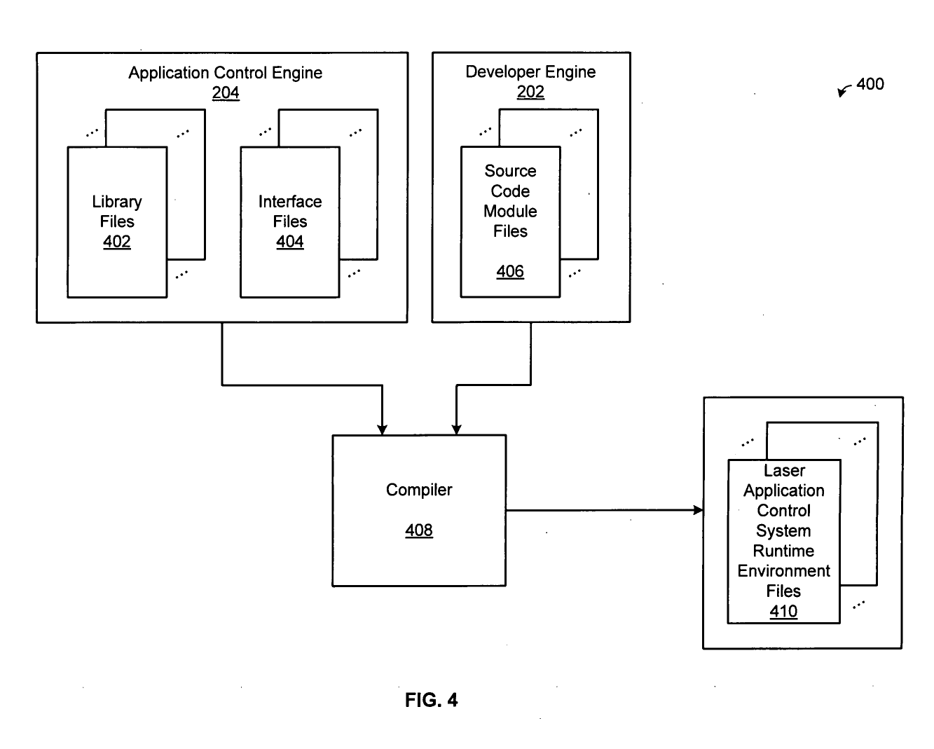

FIG. 4 illustrates an exemplary laser application control system development environment 400 in accordance with one embodiment. Modules of the application control engine 204 may be provided as a set of library files 402 and associated interface files 404. The library files 402 may include compiled object code files, while the associated interface files 404 may include source code header files and the like. The library files 402 may include a variety of versions specific to different operating systems and/or computer languages. The operating systems supported may include Windows, Linux, OS X, Unix, real-time operating systems, etc. The library files 402 may also include drivers for a variety of hardware components and software packages for software integration. For example, drivers may be provided for LabVIEW or Visual Basic.

The developer engine 202 may include a set of source code module files 406. A compiler 408 may be configured to compile the source code module files 406, the library files 402, and the interface files 404 together into a set of laser application control system runtime environment files 410, which may include executable object code corresponding to the source code module files 406.

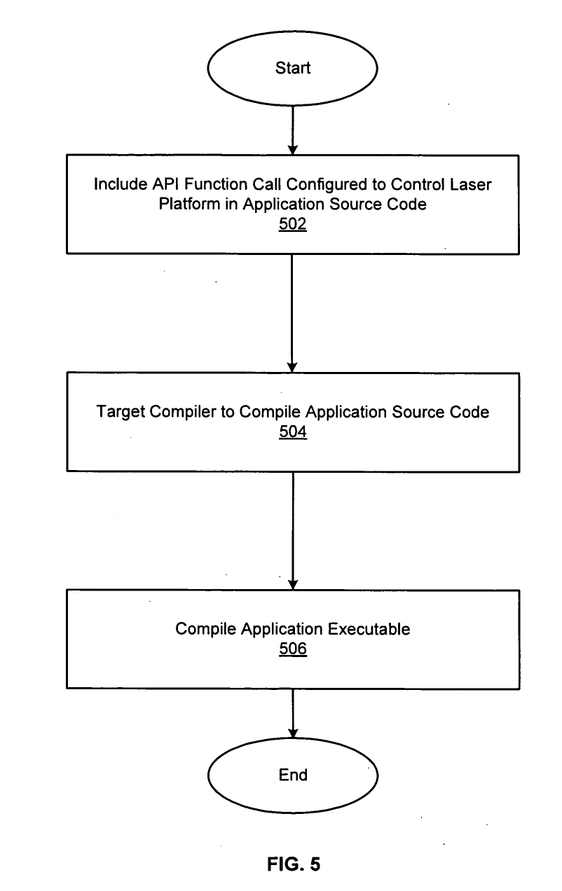

FIG. 5 illustrates an exemplary method of interfacing a laser platform, such as the laser platform 114, with a computing device. The method comprises including an application programming interface (API) function call in an application source code and compiling an executable application including the API function call using a compiler.

In step 502, an API function call is included in an application source code. The API function call may be included in the application control engine 204. The API function call may be related to the library files 402 and/or the interface files 404. The application source code may be included in the developer engine 202. The application source code may be related to the source code module files 406.

The API function call may be configured to control a first laser platform, which may be an instance of the laser platform 114. The API function call may be configured to control any number of various components of the first laser platform, such as an optical source configured to generate an optical pulse, an optical amplifier configured to amplify a power of the optical pulse, and a compressor configured to compress a temporal duration of the optical pulse. The API function call may be further configured to control a controllable parameter of the first laser platform, such as pulse width, pulse energy, pulse repetition rate, average output power, peak output power, laser system component temperature, etc. The API function call may be additionally configured to monitor a performance aspect of the first laser platform, such as optical power, pulse repetition rate, temperature, etc.

The application source code may be configured to include an additional API function call to control a second laser platform, which may be another instance of the laser platform 114. Both the first laser platform and the second laser platform may be controlled by the application source code, using one or more API function calls. In some embodiments, the application source code may be configured to control the second laser platform in response to a monitored performance aspect of the first laser platform. The application source code may be configured to monitor and/or control any number of laser platforms.

In step 504, a compiler is targeted to compile the application source code into an executable application configured to execute on a computing device. The compiler may comprise the compiler 408. The compiler may be targeted such that the executable application is configured to execute on a particular computing device or processor. Accordingly, the compiler may be targeted to use a particular subset of the library files 402, the interface files 404, and/or the source code module files 406.

In step 506, the application source code is compiled into the executable application. The compiler may compile the application source code into the executable application using relevant files associated with the application control engine 204 and the developer engine 202 on a computing processor. The compiler may convert the API function call included in the application source code into machine or object code which effectuates a change of control from object code corresponding to the developer engine 202 to object code corresponding to the application control engine 204. The particular computing device or processor on which the executable application is configured to execute may be similar to or different than the computing processor used to compile the application source code.

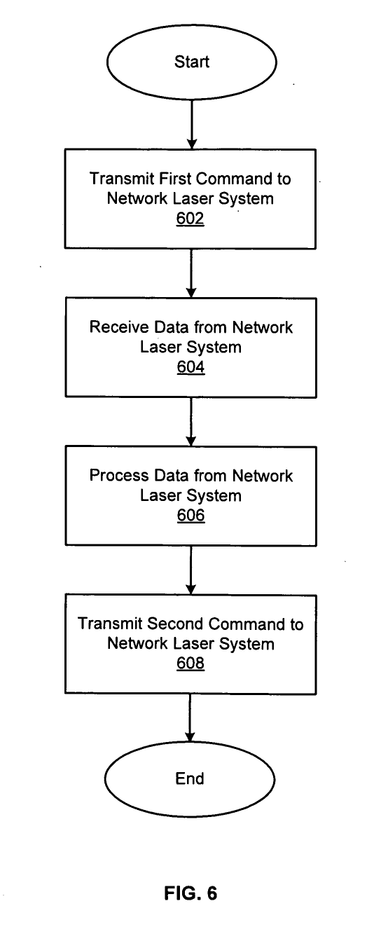

FIG. 6 illustrates an exemplary method of controlling a remote laser platform over a network, such as the network 108. The laser platform may be an instance of the laser platform 114. The laser platform may be a part of a network laser system, such as the network laser system 102. The method includes transmitting a command over a network to a network laser system, receiving data from the network laser system, processing the data from the network laser system, and transmitting a second command over the network to the network laser system in response to the data received from the network laser system.

In step 602, a first command is transmitted over a network to a network laser system. The first command may be transmitted to a network laser control logic, such as the network laser control logic 110. A computing device included in the network laser diagnostics system 106 or the laser application control system 104 may transmit the command.

In step 604, data is received from the network laser system. The data may be received from the network laser control logic. The data may include a status of the network laser system, a value of a monitored component or performance aspect, or other data. In some embodiments, the data may include a command.

In step 606, the data received in step 604 is processed. In one embodiment, a diagnostics analysis may be performed using at least the data received from the network laser system. As a result of the diagnostics analysis, a network laser system maintenance requirement may be predicted. The diagnostics analysis may also be performed using data received from the network laser system in addition to data received from one or more other network laser systems.

In additional embodiments, parameter settings required for the network laser system according to the data received in step 604 may be determined. For example, the data received in step 604 may include information relating to a material being ablated. Network laser system parameter settings required to ablate the material may be determined using the data.

In other embodiments, a control system process may be performed using the data received in step 604. The control system process may be used to determine a control command to send to the network laser system. The control system process may also determine one or more control commands to send to one or more other network laser systems.

In step 608, a second command is transmitted over the network to the network laser system. The second command may be transmitted to the network laser control logic. The second command may be transmitted in response to at least the data processing performed in step 606. For example, maintenance may be performed remotely according to a maintenance requirement predicted in step 606, or a user of the network laser system may be notified of the required maintenance. In some embodiments, programming of the network laser system may be updated remotely. In additional embodiments, system parameter settings may be downloaded to the network laser system.

In some embodiments, the second command or a third command may be transmitted to one or more other network laser systems. In these embodiments, the second or third command may be in response to the data received from the network laser control logic in step 604 and/or the data processing performed in step 606. In this manner, any number of network laser systems may be controlled in coordination with one another.

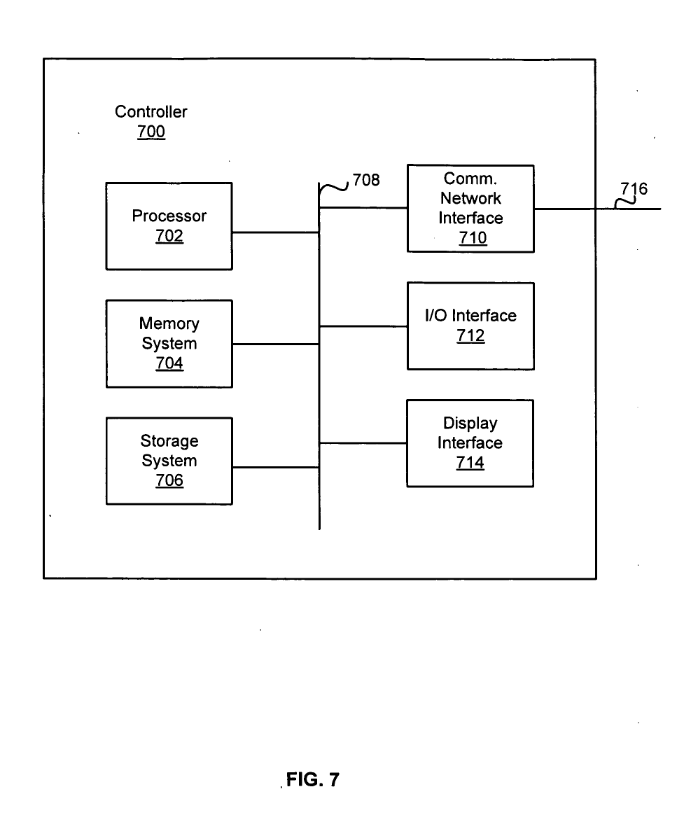

FIG. 7 illustrates an exemplary controller 700. The controller 700 may comprise any of the laser application control system 104, network laser control logic 110, and network laser diagnostics system 106 according to some embodiments. The controller 700 may comprise a processor 702, a memory system 704, and a storage system 706, which are all coupled to a bus 708. The controller 700 may also comprise a communications network interface 710, an input/output (I/O) interface 712, and a display interface 714. The communications network interface 710 may couple with the communication network 108 via a communication medium 716. In some embodiments, the controller 700 may couple to another embodiment of the controller 700, which in turn may couple with the communication network 108. The bus 708 provides communications between the communications network interface 710, the processor 702, the memory system 704, the storage system 706, the I/O interface 712, and the display interface 714.

The communications network interface 710 may communicate with other digital devices (not shown) via the communications medium 716. The processor 702 executes instructions. The memory system 704 permanently or temporarily stores data. Some examples of the memory system 704 are RAM and ROM. The storage system 706 may also permanently or temporarily store data. Some examples of the storage system 706 are hard disks and disk drives. The I/O interface 712 may include any device that can receive input and provide output to a user. The I/O interface 712 may include, but is not limited to, a keyboard, a mouse, a touchscreen, a keypad, a biosensor, a compact disc (CD) drive, a digital versatile disc (DVD) drive, or a floppy disk drive. The display interface 714 may include an interface configured to support a display, monitor, or screen. In some embodiments, the controller 700 comprises a graphical user interface to be displayed to a user over a monitor in order to allow the user to control the controller 700.

The above-described modules may be comprised of instructions that are stored on storage media (e.g., computer readable media). The instructions may be retrieved and executed by a processor (e.g., the processor 702). Some examples of instructions include software, program code, and firmware. Some examples of storage media comprise memory devices, tape, disks, and integrated circuits. The instructions are operational when executed by the processor to direct the processor to operate in accordance with embodiments of the present invention. Those skilled in the art are familiar with instructions, processors), and storage media.

In the foregoing specification, the invention is described with reference to specific embodiments thereof, but those skilled in the art will recognize that the invention is not limited thereto. Various features and aspects of the above-described invention can be used individually or jointly. Further, various embodiments of the invention can be utilized in any number of environments and applications beyond those described herein without departing from the broader spirit and scope of the specification. The specification and drawings are, accordingly, to be regarded as illustrative rather than restrictive. It will be recognized that the terms “comprising,” “including,” and “having,” as used herein, are specifically intended to be read as open-ended terms of art.

What is claimed is:

1. A system comprising:
a laser platform configured to generate an optical pulse;
monitor circuitry configured to monitor one or more performance aspects of the laser platform and generate measurement data; and
logic configured to transmit the measurement data to a remote computing device over a network.

2. The system of claim 1, wherein the laser platform comprises an optical source configured to generate a seed optical pulse, an optical amplifier configured to amplify the seed optical pulse, and a compressor configured to temporally compress the amplified optical pulse.

3. The system of claim 1, wherein the logic is further configured to perform an analysis of the measurement data and store an analysis result.

4. The system of claim 1, wherein the logic is further configured to perform a diagnostic test of the laser platform in response to instructions received from the remote computing device.

5. The system of claim 1, wherein the logic is further configured to perform maintenance in response to instructions received from the remote computing device.

6. The system of claim 1, wherein the logic is further configured to update programming in response to instructions received from the remote computing device.

7. The system of claim 1, wherein the logic is further configured to update parameter settings in response to instructions received from the remote computing device.

8. The system of claim 1, wherein the logic is further configured to control the laser platform in coordination with one or more other laser platforms over the network.

9. A method comprising:
transmitting a command over a network to a first remote laser platform configured to generate an optical pulse, the command being to monitor a performance aspect of the remote laser platform;
receiving data corresponding to the monitored performance aspect of the first remote laser platform;
processing the data corresponding to the monitored performance aspect of the first remote laser platform; and
transmitting a command to the first remote laser platform in response to at least the processed data.

10. The method of claim 9, wherein the first remote laser platform comprises an optical source configured to generate a seed optical pulse, an optical amplifier configured to amplify the seed optical pulse, and a compressor configured to temporally compress the amplified optical pulse.

11. The method of claim 9, wherein processing the data includes performing a diagnostics analysis.

12. The method of claim 11, wherein the command includes a command to perform remote maintenance of the first remote laser platform in response to the diagnostics analysis.

13. The method of claim 9, further comprising transmitting a command to control a second remote laser platform in response to at least the processed data.

14. The method of claim 9, further comprising receiving data corresponding to a monitored performance aspect of a second remote laser platform and wherein the data received from the second remote laser platform is processed in coordination with the data received from the first remote laser platform.

15. The method of claim 9, further comprising controlling the first remote laser platform in coordination with a second remote laser platform.

16. A computer readable storage medium having stored thereon a program executable by a processor to perform a method comprising:
transmitting a command over a network to a first remote laser platform configured to generate an optical pulse, the command being to monitor a performance aspect of the remote laser platform;
receiving data corresponding to the monitored performance aspect of the first remote laser platform;
processing the data corresponding to the monitored performance aspect of the first remote laser platform; and
transmitting a command to the first remote laser platform in response to at least the processed data.

17. The computer readable storage medium of claim 16, wherein the first remote laser platform comprises an optical source configured to generate a seed optical pulse, an optical amplifier configured to amplify the seed optical pulse, and a compressor configured to temporally compress the amplified optical pulse.

18. The computer readable storage medium of claim 16, wherein processing the data includes performing a diagnostics analysis.

19. The computer readable storage medium of claim 18, wherein the command includes a command to perform remote maintenance of the first remote laser platform in response to the diagnostics analysis.

20. The computer readable storage medium of claim 18, further comprising predicting a requirement for maintenance of the first remote laser platform in response to the diagnostics analysis.

21. The computer readable storage medium of claim 16, further comprising transmitting a command to control a second remote laser platform in response to at least the processed data.

22. The computer readable storage medium of claim 16, further comprising receiving data corresponding to a monitored performance aspect of a second remote laser platform and wherein the data received from the second remote laser platform is processed in coordination with the data received from the first remote laser platform.

23. The computer readable storage medium of claim 16, further comprising controlling the first remote laser platform in coordination with a second remote laser platform.

24. The computer readable storage medium of claim 16, further comprising remotely updating programming of the first remote laser platform.

25. The computer readable storage medium of claim 16, further comprising transmitting parameter settings to the first remote laser platform in response to at least the processed data.

26. The computer readable storage medium of claim 16, further comprising generating customer bills in response to at least the processed data.
